(19) United States
(12) Patent Application Publication
(10) Pub. No.: US 2003/0019682 A1
(43) Pub. Date: Jan. 30, 2003

(54) ZTR with steerable wheels

(75) Inventors: Axel Schaedler, Olmstead Falls, OH (US); Robert Rush, Put-In-Bay, OH (US)

Correspondence Address: EMERSON & SKERIOTIS, One Cascade Plaza, Fourteenth Floor, Akron, OH, 44308-1147, US

(73) Assignee: MTD PRODUCTS INC, Cleveland, OH

(21) Appl. No.: 10/173,172

(22) Filed: Jun. 17, 2002

Related U.S. Application Data
(60) Provisional application No. 60/298,760, filed on Jun. 15, 2001.

(51) Int. Cl. B60K 17/356

(52) U.S. Cl. 180/308

(57) ABSTRACT

A Zero Turn Radius vehicle is provided that utilizes a steering system including front steerable wheels that is synchronized with a drive system that has dual independent rear drive units to drive the rear wheels as well as steer the vehicle. The synchronization of the steering system with the drive system allows for true zero radius turning and reduced drag and wear on the vehicle especially the ground engaging wheels.

### I. BACKGROUND OF THE INVENTION

A. Field of Invention

The present invention relates to the art of vehicles having zero turn radius capabilities, and more specifically to zero turn radius vehicles having steerable wheels.

B. Description of the Related Art

It is known to have a vehicle with zero turn radius capabilities, commonly referred to as a ZTR vehicle. ZTR vehicles are generally propelled by independent drive wheels, which can be driven at different speeds. Steering of the ZTR vehicles is accomplished by driving independent drive wheels each at different rates of speed with respect to the other. Since the independent drive wheels provide steering capabilities for the vehicle, it is generally not necessary to have additional alternate steerable wheels. Therefore, caster wheels are used as the remaining ground engaging wheels for the vehicle in that they can be rotated at any angle as the vehicle is being propelled by the drive wheels. Such vehicles work well for their intended purpose.

One aspect with such ZTR vehicles is that when the ZTR vehicle is being maneuvered on the side of a hill, the weight of gravity tends to pull the vehicle down the hill. This may cause the portion of the vehicle supported by caster wheels to turn down the hill even when the operator does not wish to turn down the hill. What is needed is a ZTR vehicle with front steerable wheels to prevent this problem.

The present invention provides an apparatus that permits true zero radius turning combined with front steerable wheels. The difficulties inherit in the art are therefore overcome in a way that is simple and efficient, while providing better and more advantageous results.

### II. SUMMARY OF THE INVENTION

It is an object of the present invention to provide a ZTR vehicle having steerable wheels.

It is another object of the present invention to provide a ZTR vehicle having two drive wheels and two asynchronous steering wheels.

It is yet another object of the present invention to provide a ZTR vehicle having front steerable wheels with gear reduction boxes that produce a steering output greater than the steering input.

It is yet another object of the present invention to provide a ZTR vehicle with a steering system that reduces the drag and wear on ZTR vehicles.

It is still another object of the present invention to provide a ZTR vehicle with front steerable wheels, where the front wheels are steered asynchronously with respect to each and the front wheels are steered in synchronous with the rear wheels of the vehicle.

It is yet another of the present invention to provide a ZTR vehicle having three distinct modes of synchronized steering.

A ZTR vehicle, which may be a riding mower, includes a steering mechanism that controls steering of the rear drive wheels of the vehicle and the front wheels. A pivotable steering member includes rigid steering rods. Two front rods are included that asynchronously pivot the front wheels when the steering member is turned. Likewise, two rear rods adjust the pintle shafts of two respective hydrostatic drives, one connected to each of the rear wheels. In this way, steering the vehicle, via a steering member, synchronously steers the front wheels with respect to the back wheels and asynchronously steers one of the front wheels with respect to the other front wheel.

Other objects and advantages of the invention will appear from the following detailed description of the preferred embodiment of the invention with reference being made to the accompanying drawings.

### III. BRIEF DESCRIPTION OF THE DRAWINGS

The invention may take physical form in certain parts and arrangement of parts, a preferred embodiment of which will be described in detail in this specification and illustrated n the accompanying drawings which form a part hereof and wherein:

FIG. 1 is a side view of the ZTR vehicle.

FIG. 1 a is a side view of the ZTR mower.

FIG. 2 is a schematic representation of the drive system of the present invention.

FIG. 2a is a schematic representation of the fluid power circuit of the drive system.

FIG. 3 is a partial schematic representation of the steering system showing the rear drive wheel control.

FIG. 4 is a partial top view of the steering system showing the first and second steering outputs.

FIG. 5 is a perspective view of the front of the vehicle showing the front steerable wheels.

FIG. 6 is a perspective view of a front steerable wheel showing the gear reduction unit.

FIG. 7 is a schematic representation of the first mode of steering.

FIG. 8 is a schematic representation of the ground engaging wheels turning about a point exterior to the wheel base of the vehicle.

FIG. 9 is a schematic representation of the second mode of steering.

FIG. 10 is a schematic representation of the third mode of steering showing a zero radius turn.

### IV. DESCRIPTION OF THE PREFERRED EMBODIMENT

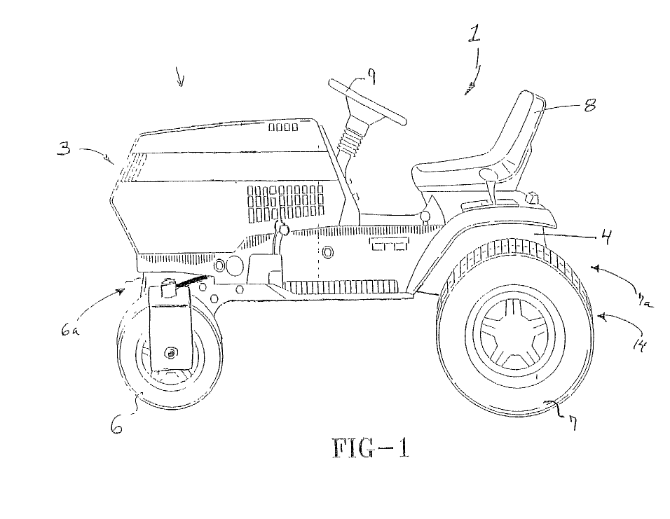

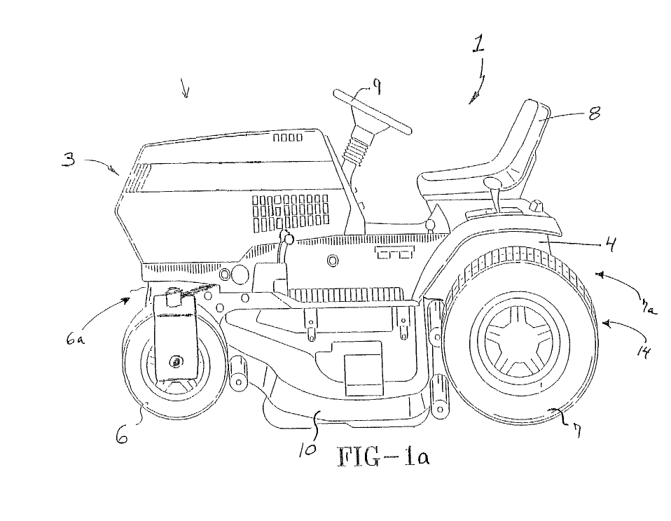

Referring now to the drawings wherein the showings are for purposes of illustrating a preferred embodiment of the invention only and not for purposes of limiting the same, FIG. 1 depicts a Zero Turning Radius vehicle 1. A Zero Radius Turning vehicle is a vehicle that turns about a point midway between the drive wheels of the vehicle. This may be accomplished by driving the drive wheels in different directions at approximately the same magnitude of speed. In this manner, the radius of turning the vehicle is substantially zero with respect to the lateral midpoint of the vehicle, and more specifically to the midpoint of the drive axle. The radius of turning may be increased from zero to any point interior to the wheelbase of the vehicle 1 or even exterior to the wheelbase of the vehicle as is well know in the art. Any radius of turning may be accomplished by varying the magnitude of the speed and direction of one drive wheel with respect to the other drive wheel. In that turning a vehicle about a point interior to the wheelbase of a vehicle is well known in the art no further explanation will be offered at this point. The vehicle 1 of the present invention includes a frame 4 upon which the components of the vehicle 1 are connected. The vehicle may include an internal combustion engine 3 to provide power to drive or propel the vehicle. However any type of engine 3 may be included that provides power to the vehicle 1. The vehicle 1 may include first and second front ground engaging wheels 6, 6a that are rotatably connected with respect to the frame, in any manner well known in the art, for use in facilitating locomotion for the vehicle 1. The front ground engaging wheels 6, 6a may also be pivotable about an axis as shown in FIG. 1, as will be discussed further in a subsequent paragraph. In this manner, the front ground engaging wheels 6, 6a are steerable. The vehicle 1 may also include first and second rear ground engaging wheels 7, 7a. In the preferred embodiment, the rear ground engaging wheels 7, 7a are rotatably connected with respect to the frame 4. The rear ground engaging wheels 7, 7a are independently driven, which is to say that one of the rear ground engaging wheels 7, 7a may be driven at a different speed and direction with respect to the opposing ground engaging wheel. This may be accomplished by incorporating independently driven hydrostatic drives, or any drive means chosen with sound engineering judgment. The vehicle 1 may also include a steering implement 9, which in the preferred embodiment is a steering wheel 9. However, it is expressly noted that any steering implement 9 may be chosen with sound engineering judgment that is appropriate for use in a ZTR vehicle including but not limited to steering levers, a steering rod or joystick, not shown. The steering implement 9 may be communicated to pivot the front ground engaging wheels 6, 6a while controlling the speed and direction that the rear ground engaging wheels 7, 7a are driven as will be discussed in detail in a subsequent paragraph. The vehicle 1 may be a vegetation mower 1 having a mower deck 10, shown clearly in FIG. 1a. The mower deck 10 may be mounted to the vehicle 1 in any manner chosen with sound engineering. The type of mower shown in FIG. 1a is a riding mower. However, it is to be understood that applications for the present invention are not limited to riding mowers.

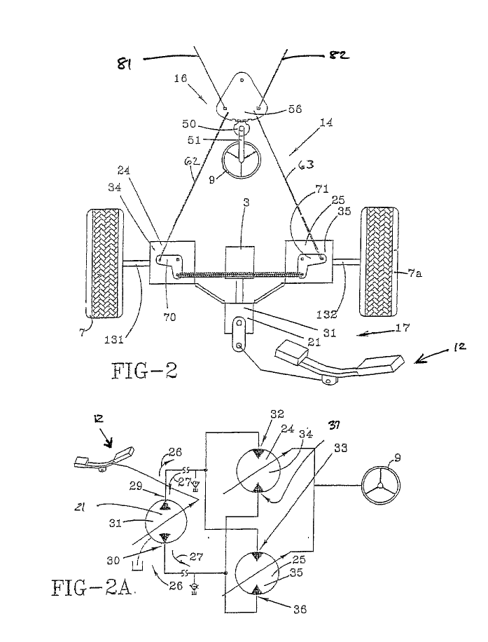

With reference now to FIG. 2 and 2a, the drive system 14 of the vehicle 1 will now be discussed. As previously mentioned, the vehicle 1 may include selectively independently engageable drive means, which may be first and second hydrostatic drives or motors 34, 35. The drive system 14 may include a means 17 for accelerating the vehicle 1, which may include a bi-directional pedal member 12. The drives means 14 may also include a hydraulic pumping means 21 and first and second actuators 24, 25. The hydraulic pumping means 21 may be a double acting variable displacement hydraulic pump 31 that is coupled to the engine 3 in a manner well known in the art. In this way, power output from the engine 3 is transferred to the hydraulic pumping means 21 for use in providing power to operate the first and second hydrostatic drives 34, 35. In the preferred embodiment, each of the first and second actuators 24, 25 or first and second hydrostatic drives 34, 35 are respectively connected to the rear ground engaging wheels 7, 7a. In this manner, in that the hydrostatic drives may be independently driven in different direction and with different magnitudes of speed, the rear ground engaging wheel 7, 7a may also be independently driven. In the preferred embodiment, the first and second actuators 24, 25 may be first and second double acting variable displacement hydraulic motors 34, 35, or first and second hydrostatic motors 34, 35. The first and second double acting hydraulic drive motors 34, 35 include output shafts 131, 132 that may be coupled to first and second rear ground engaging wheels 7, 7a, respectively, so that, when the hydraulic motors 34, 35 are engaged, rotational power is transferred to the first and second ground engaging wheels 7, 7a, respectively. In other words, when the first hydraulic motor 34 is engaged, rotational output power is transferred to the first ground-engaging wheel 7. In this manner, the output shaft 131 is a first drive output. Similarly, when the second hydraulic motor 35 is engaged, rotational output power is transferred to the second ground engaging wheel 7a. Likewise, the second output shaft 132 is a second drive output. It is expressly noted that the first hydraulic motor 34 is coupled to the first ground engaging wheel 7, independent of the second hydraulic motor 35 being coupled to the second ground engaging wheel 7a. In other words, the first and second ground engaging wheels 7, 7a may be independently driven. Any manner of operatively connecting the hydraulic motors 34, 35 to the ground engaging wheels 7, 7a, respectively, may be chosen with sound engineering judgment.

With continued reference to FIG. 2 and now also to FIG. 2a, a schematic representation of the drive system is shown. In the preferred embodiment, the drive system 14 may incorporate fluid power to provide mobility to the vehicle 1. Output power or output fluid power from the pumping means 21 may be connected in parallel to the first and second hydraulic actuators 24, 25, as clearly shown in FIG. 2a. That is to say that the pumping means 21 provides at least a first output that is hydraulically connected to each of the first fluid power inputs of the first and second hydraulic actuators 24, 25. As previously stated, the preferred embodiment of the present invention includes a double acting variable displacement hydraulic pump 31, as part of the pumping means 21. In this manner, the hydraulic pump 31 has first and second fluid power outputs that flow in first and second directions 26, 27. In the first direction 26, fluid power output of the hydraulic pump 31 flows from a first port 29, as schematically shown in FIG. 2a, to first ports 32, 33 of the first and second hydraulic actuators 24, 25, respectively. In this manner, the fluid power output from the hydraulic pump 31 is connected in parallel to the first and second hydraulic actuators 24, 25. Likewise, in the second direction 27, fluid power output of the hydraulic pump 31 may also flow from second port 30 to second ports 37, 36 of the first and second hydraulic actuators 24, 25, respectively. It is expressly noted, at this point, that additional hydraulic componentry or circuitry may be incorporated in the hydraulic system, as is chosen with sound engineering judgment. As is well known in the art, the fluid power output of a double acting variable displacement hydraulic pump 31 is caused to flow in first and second directions 26, 27, by the selective adjustment of a swash plate or wobble plate contained within the pump, not shown in the figures. Typically, a pintle shaft is operatively connected to selectively adjust the swash plate or wobble plate. In that the selective adjustment of swash plates and the operation of double acting variable displacement hydraulic pumps is well known in the art, no further explanation will be offered at this point.

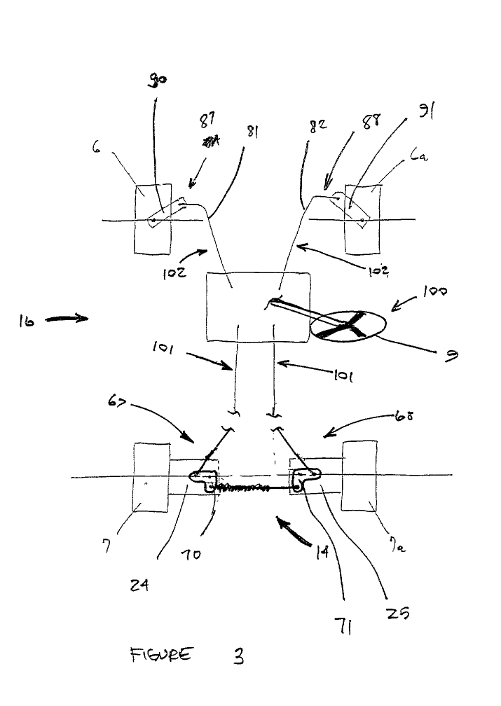

With reference now to FIG. 3, a schematic representation of the steering system, shown generally at 16, includes a first steering input 100, and first and second steering outputs 101, 102. Input to the steering system 16 may be accomplished via steering wheel 9, steering shaft 51 and steering pinion member 50.

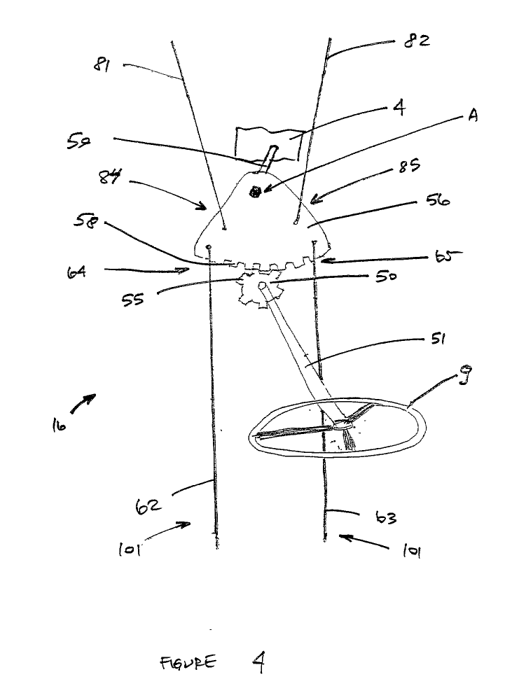

With reference to FIG. 3 and now to FIG. 4, the steering system 16 is discussed in detail. The steering wheel 9 is shown connected to a steering pinion 50 or steering pinion member 50, via steering shaft 51. In the preferred embodiment, the steering wheel 9 may be selectively adjusted or rotated in first and second directions by associated operator, which may be clockwise and counterclockwise directions. The steering pinion member 50 may include gear teeth 55 that meshingly engage with gear teeth of a steering member 56. The steering pinion member 50 may be rotatably mounted with respect to the frame 4 via bearing, bushing or any other means chosen with sound engineering judgment. Likewise, the steering wheel 9 or steering implement 9 may be rotatably connected to the frame 4 via any means chosen with sound engineering judgment. It is noted that in the preferred embodiment, the steering wheel 9 and steering pinion member 50 may be selectively rotated through substantially 120 degrees of movement. That is to say that the steering wheel 9 may be selectively rotated 60 degrees in a first direction with respect to a neutral steering position and may be rotated 60 degrees in a second direction. In other words, the steering wheel 9 provides a first steering input 100 to the steering system 16. The neutral steering position may be the steering position where the vehicle is being driven in substantially a straight direction of motion. It is noted the range of degrees through the steering wheel 9 or steering pinion member 50 is rotated may reside within the range of 90 degrees to 150 degrees. However, any range of through which the steering wheel 9 and steering pinion member 50 is adjusted may be chosen with sound engineering judgment.

With continued reference to FIGS. 3 and 4, the steering system may include steering means or a steering wheel 9, as previously discussed, which is shown connected to a steering pinion 50, via steering shaft 51. It is noted that any means for providing a steering input may be chosen with sound engineering judgment, including but not limited to a joystick or steering levers. The steering pinion 50 may meshingly engage with teeth 58 of steering member 56. The steering member 56 may be pivotally attached to the frame 4, via pivot pin 59, as clearly shown in FIG. 4. The steering member 56 may be pivotally connected with respect to the frame 4 of the vehicle 1 via bearings, bushings, or any other means chosen with sound engineering judgment. In this manner, rotation of the steering means 9 synchronously rotates steering pinion 50, which rotates steering member 56 about pivot pin 59. In the preferred embodiment, the steering system 16 includes a first steering output 101 comprising first and second rear rod members 62, 63 to the drive system for use in selectively independently rotating the rear drive wheels 7, 7a. In this manner, the first steering output 101 communicates a control signal to drive the rear ground engaging wheels 7, 7a. It is noted that selective turning of the steering wheel 9 adjusts both of the rear rod members 62, 63 slowing down one drive actuator, and corresponding ground engaging wheel, while speeding up the other. In this manner, the adjustment of the rear rod members 62, 63 constitute a first steering output. The first and second rear rod members 62, 63 have first 64, 65 and second 67, 68 ends respectively. The first ends 64, 65 of the rear rod members 62, 63 are fixedly attached, one to each side of the steering member 56, as clearly shown in FIG. 3. Likewise, the second ends 67, 68 of the first and second rod members 62, 63 may be pivotally connected to the pintle links 70, 71 of the first and second actuators 24, 25 for use in controlling the position of the pintle links 70, 71. In this way, the steering member 56 is operatively communicated to both of the first and second actuators 24, 25, which make up the first steering output 101. In the preferred embodiment, rod members 62, 63 may be rigid mechanical rod members that transfer both tension and compression forces. However, any means of transferring tension forces may be chosen with sound engineering judgment, including flexible, tension-bearing cables that transfers tension force in a manner consistent with the present invention.

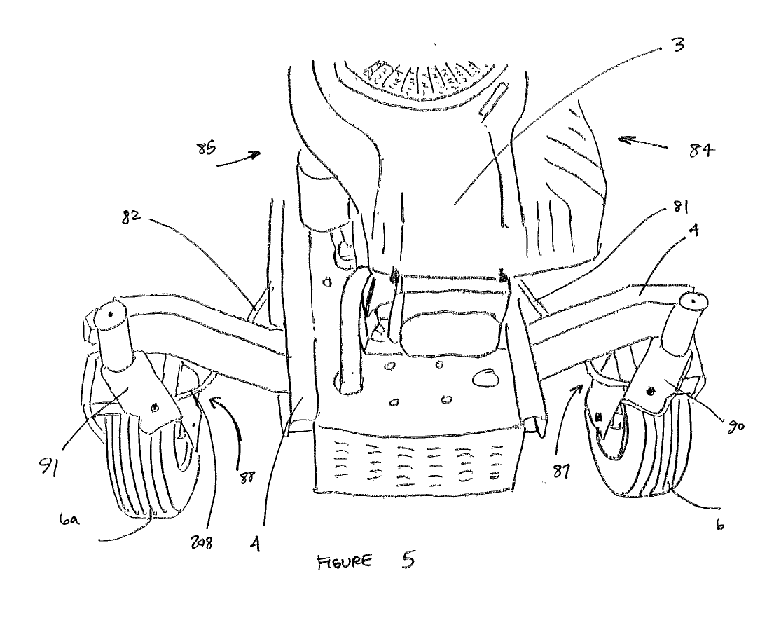

With continued reference to FIG. 3 and 4 and now to FIG. 5, a first front rod member 81 is shown operatively attached at a first end 84 to the toothed steering member 56 and at a second end 87 to a steering extension member 90 of the first front steerable wheel 6. Similarly, a second front rod member 82 is shown operatively attached at a first end 85 to the tooth steering member 56 and at a second end 88 to the steering extension member 91 of the second front steerable wheel 6a. In the preferred embodiment, the second respective ends 87, 88 of the front rod members are fashioned to curve outwardly in a manner shown clearly in the figures. However, any orientation or configuration of steering rods may be chosen with sound engineering judgment. As the toothed steering member 56 is pivoted about point A, reference FIG. 4, via the steering pinion 50, the front rod members 81, 82 operatively pivot the respective extension members 90, 91 thereby steering each of the front wheels. It is noted, that the extension members are rigidly attached to the front ground engaging wheel frame portions respectively and have a characteristic longitudinal axis. Additionally, the extension members 90, 91 may be fashioned in such a manner that the longitudinal axis of the extension members 90,91 forms an acute angle with respect to a longitudinal axis of the vehicle. However, any orientation of the extension members 90, 91 may be chosen with sound engineering judgment. In this manner, pivoting the steering wheel 9, which will pivot the toothed steering member 56 will steer each of the respective front ground engaging wheels 6, 6a at differentially varying angles throughout the turning radius of the vehicle. Therefore, the steering wheel 9 operatively pivots or steers the front ground engaging wheels 6, 6a and operatively engages the drive system to steer the rear ground engaging wheels 7, 7a by driving the actuators 24, 25 at different magnitudes of speed and direction. That is to say that the steering wheel 9 selectively provides a first steering input 100 to the steering system 16 and the steering system 16 provides a first steering output 101 to steer the rear wheels 7, 7a and second steering output 102 to steer the front wheels 6, 6a. Steering of the front ground engaging wheels 6, 6a in this manner, is synchronized with the steering of the rear ground engaging wheels 7, 7a by timing the steering angle of the front ground engaging wheels 6, 6a with the actuation of the hydraulic actuators 24, 25 causing differential outputs to each of the respective drive wheels 7, 7a.

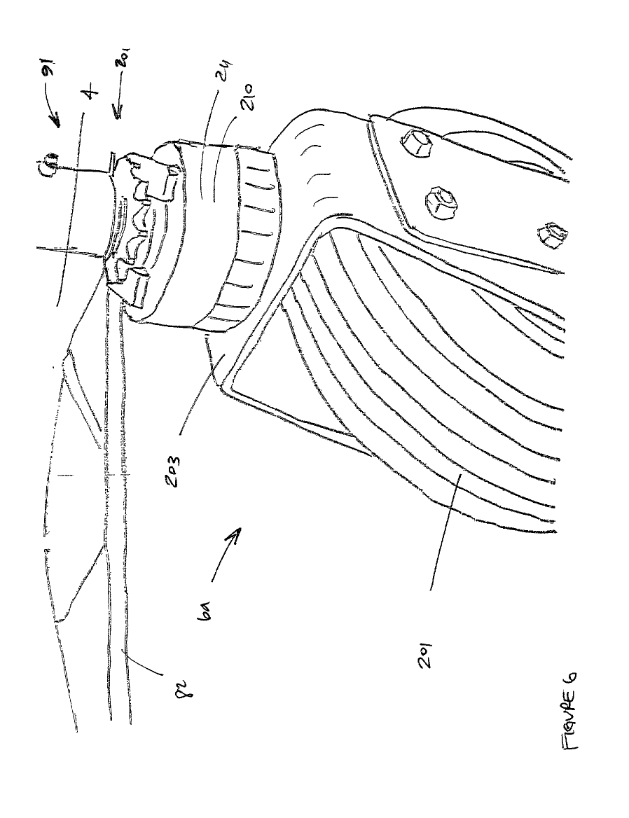

With continued reference to FIGS. 3 through 5 and now to FIG. 6, front ground engaging wheel 6a is shown. The front ground engaging wheel 6 may include a tire portion 201 and a wheel-housing portion 203. The wheel-housing portion 203 may provide support for rotatably receiving the tire portion 201 for use in facilitating locomotion for the vehicle 1. Any manner of connecting the tire portion 201 to the wheel-housing portion 203 may be chosen with sound engineering judgment. The wheel-housing portion 203 may be pivotably attached to the frame 4 of the vehicle 1 via a wheel-housing pivot shaft 206. The wheel-housing pivot shaft 206 may be received internal to the frame 4 and pivotably attached thereto via bearing, bushings or the like. It is noted that the wheel-housing pivot shaft 206 may be of any configuration chosen with sound engineering judgment. In this manner, the front ground engaging wheels 6, 6a are rotatably connected with respect to the frame 4 and steerably connected with respect to the frame 4 of the vehicle 1. As previously mentioned, an extension member 91 is fixedly attached to the wheel-housing portion 203 and extends substantially perpendicularly axially outward with respect to a centerline of the wheel-housing pivot shaft 206. The second front rod member 82 may be pivotally connected to the extension member 91 in such a manner that when force is applied, via the rod member 82, extension member 91 may pivot the wheel-housing portion 203 resulting in the steering of wheel 6a. In the preferred embodiment, the rod member 82 is rigid for use in transmitting tension and compression forces needed to pivot the wheel-housing portion 203. It is noted that the rod member 82 may also include a curved portion 208, shown in FIG. 5. However, any configuration of rod member 82 may be chosen with sound engineering judgment as is appropriate for steering the front ground engaging wheels 6, 6a. It should be appreciated that aforementioned discussion relates equally to the opposing side of the vehicle 1 including front ground engaging wheel 6 and the related components associated therewith.

With continued reference to FIG. 6, a gear ratio means 210 is shown connected between the frame 4 and wheel-housing portion 203. In this manner, the wheel-housing pivot shaft 206 is received by the gear ratio means 210. Additionally, the gear ratio means 210 is received by the frame 4 in any manner chosen with sound engineering judgment. In the preferred embodiment, the gear ratio means 210 is a gear box 211 that changes the rotational output of the gear box 211 with respect to an input of the gear box 211. It is noted that any type of gear reducing unit may be chosen with sound engineering judgment that alters the input with respect to the output. In that the function of a gear box is well known in the art, no further explanation will be offered at this point. The extension member 91 may be connected to the input of the gear ratio means 210. Similarly, the wheel-housing pivot shaft 206 may be connected to the output of the gear ratio means 210. In this manner, when the extension member 91 is rotated through an angle, via the steering system 16 and rod member 82, the wheel-housing pivot shaft 206 is rotated through a different angle with respect to the input angle of the extension member 91, and steering system 16. In that the wheel-housing pivot shaft 206 may be attached to the wheel-housing portion 203, the front wheel 6 is subsequently rotated or steered. The range of input of the steering system 16, is from 90 degrees to 150 degrees as previously discussed. However, any range of steering input may be chosen with sound engineering judgment. In the preferred embodiment, the steering input extends 120 degrees. The output of the gear ratio means 211 may be 1:1.5, which translates the steering input to the gear ratio means, which may have 180 degrees of steering output. In other words, rotating the extension member 91 60 degrees in a first direction may rotate the wheel 6 90 degrees in the same direction. The ratio of input of the gear ratio means 210 to output of the same may range from 1:1 to 1:3. However, it is expressly noted that any ratio of gear reducing means may be chosen with sound engineering judgment.

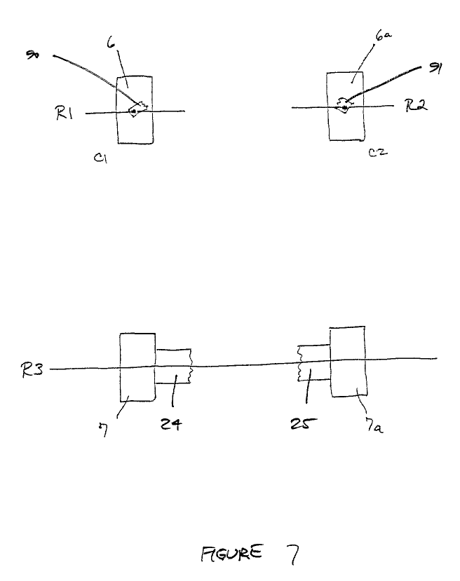

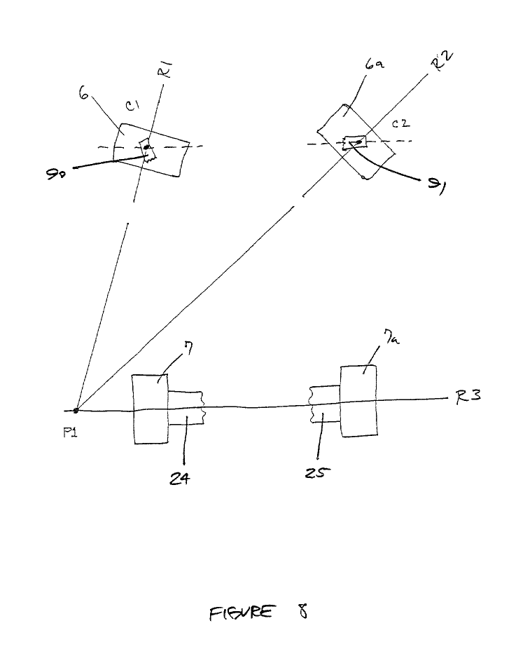

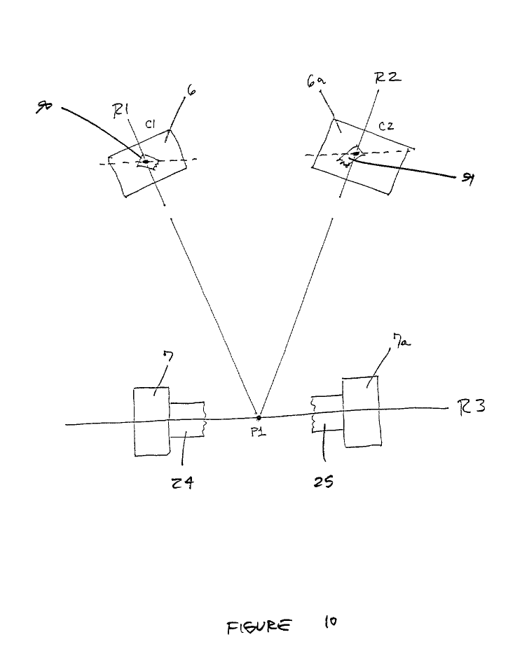

With reference now to FIGS. 7 through 10, a brief discussion about the turning point of the vehicle 1 will now be presented. FIG. 7 shows a schematic representation of the four ground engaging wheels of a vehicle, wherein the vehicle 1 includes two independently rear drive wheels and two front steerable wheels. When the vehicle 1 is being propelled in a forward direction of travel, via actuators 24, 25, with no steering imposed on the vehicle 1, the front steerable wheels 6 ,6a are substantially parallel with respect to the forward direction of travel. When the vehicle 1 is turning the inside ground engaging wheel, that is the inside wheel with respect to the direction that the vehicle is turning, may travel in a tighter radius than the outside engaging wheel, reference FIG. 8. Therefore, it is necessary to steer each of the front steerable wheels 6, 6a at different angles with respect to each other in order to prevent unnecessary drag and wear on the ground engaging wheels. The difference in angular rotation between the front steerable wheels 6, 6a is dependent upon the turning radius P1 of the vehicle. As previously mentioned, the turning radius may reside along an axis coincident with the axis of rotation of the rear ground engaging wheels 7, 7a. In a conventional non-ZTR vehicle the turning radius typically resides outside of the wheel base of the vehicle. However, with a ZTR vehicle, the turning radius of the vehicle may reside exterior to the wheel base, interior to the wheel base or be laterally centered about the wheel base of the vehicle, as shown in FIG. 10. It is noted that the position of the turning point of the vehicle is dependent upon the difference in speed and direction that the rear ground engaging wheels are driven.

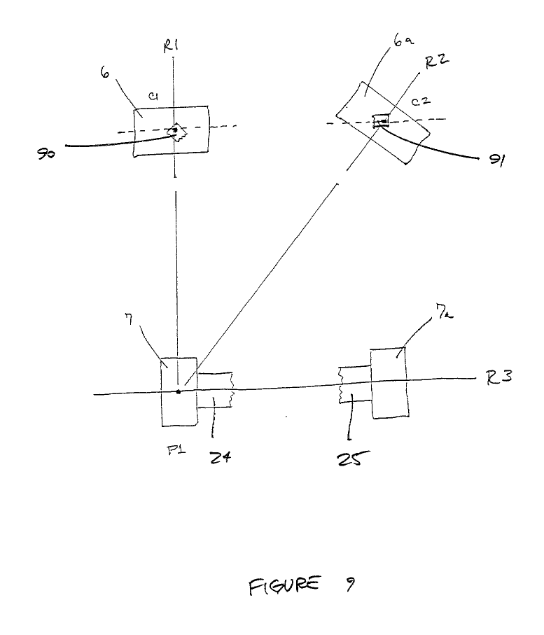

With reference to FIGS. 7 through 10, the radii of turning will now be discussed. When the vehicle 1 is moving substantially straight ahead, that is to say there is no steering input to turn the vehicle 1, the wheels rear wheels 7, 7a may be driven at the same speed and same direction. In this instance, the front wheel 6, 6a are disposed substantially parallel with the longitudinal axis of the vehicle 1. When the steering wheel 9 is turned in a first direction the steering wheel 9, via steering system 16, will drive one of the rear wheels faster the other and at the same time pivot the front steering wheels 6, 6a. When this is occurring the front wheels 6, 6a will be steered at different angles with respect to the other. In this manner the front wheels 6, 6a are being steered in synchronous with the rear wheels 7, 7a and the first front wheel 6 is being steering asynchronously with respect to the second front wheel 6a, as depicted by FIG. 8. It is noted that the point P1 about which the vehicle 1 turns is outside the wheel base of the vehicle 1, as shown in FIG. 8. Further turning of the steering wheel will cause P1 to move inward toward the vehicle 1. At the point where P1 resides centered over wheel 7, shown in FIG. 9, the front wheel 6 is steered to where the axis of rotation R1 of front wheel 6 is substantially coincident with a first line L1 defined by point P1 and the center point C1 of wheel 6. Likewise, front wheel 6a is steered to where the axis of rotation R2 of front wheel 6a is coincident with a second line L2 defined by point P1 and the center point C2 of front wheel 6a. It is noted that the front wheels 6, 6a are steered at different angles from each other with respect to a common axis, which may be the longitudinal axis of the vehicle 1. In this instance, front wheel 6 is has been steered 90 degrees from the longitudinal axis of the vehicle 1. And front wheel 6a, has been steered at a lesser angle than that of front wheel 6. In this instance, the angle at which front wheel 6a is steered may depend upon the length of the vehicle 1. Any steering angle may chosen with sound engineering judgment as is appropriate for the minimizing drag of that particular wheel. As the steering wheel 9 is turned further still to where the turning radius is zero, the steering system 16 will adjust the actuators 24, 25 to drive in opposite directions and at substantially the same speed, typically known as ZTR turning, as shown clearly in FIG. 10. In this position P1 may reside centered laterally between the rear wheels 7, 7a. In this instance, the steering system 16 will steer the front wheels 6, 6a asynchronously, that is to say with respect to the each other, to where the axes of rotation R1, R2 of the front wheels are coincident with lines L1 and L2.

With continued reference to FIGS. 7 through 10, the front wheels 6, 6a may be synchronized at three distinct modes of the operation with the rear wheels 7, 7a. FIG. 7 shows the first mode of synchronized operation in that the steering wheels are not rotated with respect to the longitudinal axis but are each substantially parallel with respect to a forward direction of travel. In this first mode the rear wheels may be each driven at substantially the same speeds and direction. In this manner, the steering wheel is positioned for moving the vehicle 1 in a substantially straight line. FIG. 9 clearly shows the second mode of synchronized steering operation wherein the turning point of the vehicle resides at the midpoint of one of the right rear driving wheels 7. In the second mode the front wheel 6 is steered perpendicular to the longitudinal axis and the front wheel 6a is oriented at an angle less than 90 degrees to minimize wherein drag on the ground engaging wheels. It is noted at this point that any orientation of the left front steerable wheel may be chosen as is appropriate for minimizing drag and wear on the ground engaging wheels. FIG. 10 clearly shows the third mode of synchronized steering operation. This mode of operation represents a zero turning radius. In the third mode of operation each of the respective front steerable wheels are rotated so as to minimize wear and drag on the ground engaging wheels for a ZTR turn. It is noted, that any angle of orientation may be chosen for the third mode of operation that is appropriate for minimizing wear and drag on the ground engaging wheels. In the second and third mode of operation, the steering wheel is operatively communicated to the drive system so that differential operation of the back drive wheels is synchronized with the steering of the front steerable wheels. In this manner, operation of the front steerable wheels is synchronized with operation of the rear drive wheels. It is especially noted, that rotation of the steering wheel causes differential steering of the respective front and back wheels throughout the entire turning radius. In other words, differential steering, of both of front and rear wheels, is accomplished in between each of the three synchronized steering points or modes of operation. However, it is noted that any number of modes of operation or points of synchronized steering may be chosen with sound engineering judgment. It is to be understood that the descriptions detailed herein relate equally to steering the vehicle 1 in both the first and second directions.

With reference to all of the Figures, it is contemplated in an alternate embodiment that as the front wheels are steered through the full range of steering angles, as previously discussed, the axes of rotation R1, R2 of each of the front wheels 6, 6a may be coincident with lines L1 and L2 throughout the full range of steering. However, in the preferred embodiment, the axes of rotation R1, R2 are coincident with lines L1 and L2 at least three distinct modes of operation, as shown respectively by FIG. 7, 9 and 10.

While specific embodiments of the invention have been described and illustrated, it is to be understood that these embodiments are provided by way of example only and that the invention is not to be construed as being limited thereto but only by proper scope of the following claims.

I/we claim:

1. A Zero Radius Turning vehicle, comprising:
a frame;
an engine operatively attached to the frame;
at least a first front ground engaging wheel operatively rotatably connected with respect to the frame, the at least a first front ground engaging wheel being operatively steerably connected with respect to the frame;
first and second rear ground engaging wheels operatively rotatably connected with respect to the frame;
a drive system operatively steerably connected to the first and second rear ground engaging wheels for use in steering the mower by driving the first rear ground engaging wheel at a substantially different speed with respect to the second rear ground engaging wheel; and,
a steering system having a first steering input and first and second steering outputs, wherein the first steering output is operatively communicated to the drive system for use in providing steering control to the drive system, wherein the second steering output is operatively communicated to the at least a first front ground engaging wheel for use in steering the at least a first front ground engaging wheel.

2. The vehicle of claim 1, wherein the drive system includes first and second hydrostatic drives operatively communicated to the first and second rear ground engaging wheels respectively.

3. The vehicle of claim 2, wherein the steering system includes:
a steering member pivotally connected with respect to the frame, wherein when the steering member is pivoted in a first pivoting direction the speed of the first rear ground engaging wheel is increased with respect to the second rear ground engaging wheel and the first and second front ground engaging wheels are increasingly steered with respect to a first steering direction, wherein when the steering member is pivoted in a second pivoting direction the speed of the second rear ground engaging wheel is increased with respect to the first rear ground engaging wheel and the first and second front ground engaging wheels are increasingly steered with respect to a second steering direction.

4. The vehicle of claim 3, wherein the steering member includes gear teeth and wherein the steering system further comprises:
a steering pinion having gear teeth, the steering pinion being rotatably connected to the frame, the steering pinion being operatively meshingly engaged with the steering member; and,
a steering wheel fixedly connected with respect to the steering pinion for use in receiving steering input from an associated operator.

5. The vehicle of claim 4, further comprising:
a first gear reducing unit operatively connected between the first front ground engaging wheel and the first steering output, and a second gear reducing unit operatively connected between the second front ground engaging wheel and the first steering output.

6. The vehicle of claim 5, wherein the first steering output includes:
a first rod member having first and second ends, the first end of the first rod member being operatively fixedly connected to the steering member, the second end of the first rod member being operatively connected to the first front ground engaging wheel for use in steering the first front ground engaging wheel;
a second rod member having first and second ends, the first end of the second rod member being operatively fixedly connected to the steering member, the second end of the second rod member being operatively connected to the second front ground engaging wheel for use in steering the second front ground engaging wheel; and,
wherein when the steering member is pivoted in the first pivoting direction the first front ground engaging wheel is pivoted an angle A1 and the second front ground engaging wheel is pivoted an angle A2, wherein angle A1 is substantially different from A2.

7. The vehicle of claim 6, further comprising:
a mower deck operatively connected to the frame.

8. A mower, comprising:
a frame;
an engine operatively attached to the frame;
a mower deck operatively connected to the frame;
first and second front ground engaging wheels being rotatably and steerably connected to the frame, the first front ground engaging wheel having a center point C1 and an axis of rotation A, the second front ground engaging wheel having a center point C2 and an axis of rotation B;
first and second rear ground engaging wheels operatively rotatably connected to the frame, wherein the first rear ground engaging wheel is operatively driven at a substantially different speed with respect to the second rear ground engaging wheel, wherein when the first rear ground engaging wheel is driven at a different speed with respect to the second rear ground engaging wheel the vehicle turns about a point P1; and,
wherein when the first rear ground engaging wheel is driven at a different speed with respect to the second rear ground engaging wheel the first front ground engaging wheel is steered so that the axis of rotation A coincides with a line defined by points P1 and C1, wherein when the first rear ground engaging wheel is driven at a different speed with respect to the second rear ground engaging wheel the second front ground engaging wheel is steered so that the axis of rotation B coincides with a line defined by points P1 and C2.

9. A mower, comprising:
a frame;
an engine operatively attached to the frame;
a mower deck operatively connected to the frame;
first and second front ground engaging wheels operatively rotatably connected to the frame, the first and second front ground engaging wheels being operatively pivotally connected with respect to the frame respectively;
first and second rear ground engaging wheels operatively rotatably connected to the frame, the first and second rear ground engaging wheels operatively steerably connected with respect to the frame;
a steering member pivotally attached to the frame, the steering member operably communicated to steer the first and second rear ground engaging wheels, the steering member operably communicated to pivot the first and second front ground engaging wheels;
wherein when the steering member steers the first and second rear ground engaging wheels the steering member pivots the first and second front ground engaging wheels; and,
wherein the first front ground engaging wheel is pivoted asynchronously with respect to the second front ground engaging wheel.

11. The mower of claim 10, further comprising:
a steering implement operatively connected with respect to the frame for use in receiving a first steering input from an associated operator;
a steering pinion member rigidly connected to the steering implement, the steering pinion member having meshingly engaging teeth; and,
wherein the steering pinion member operatively engages the steering member.

12. The mower of claim 10, further comprising:
a first gear reducing unit operatively connected between the first front ground engaging wheel and the steering member; and,
a second gear reducing unit operatively connected between the second front ground engaging wheel and the steering member.
